(19) United States
(12) Patent Application Publication
(10) Pub. No.: US 2026/0100846 A1
(43) Pub. Date: Apr. 9, 2026

(54) VALIDATING RESULT SETS USING A ZERO TRUST MECHANISM

(71) Applicant: AnyLog, Inc., Redwood City, CA (US)

(72) Inventors: Moshe Shadmon, Redwood City, CA (US); Roy Shadmon, Redwood City, CA (US)

(21) Appl. No.: 19/349,585

(22) Filed: Oct. 3, 2025

Related U.S. Application Data
(60) Provisional application No. 63/705,494, filed on Oct. 9, 2024.

(51) Int. Cl. H04L 9/32

(52) U.S. Cl. CPC H04L 9/3236

(57) ABSTRACT

A method for improving trust in a decentralized physical infrastructure network (DePIN), the method including receiving, by a client device, a result set created by executing a request on a source data from at least one of a plurality of operator nodes of the DePIN, validating the source data by calculating one or more hash values of the source data and comparing the one or more calculated hash values with one or more original hash values published on a shared metadata layer, and validating the result set, by executing the request on the source data after validation to generate a validating set and comparing the validating set with the result set to determine accuracy of the result set.

### CROSS-REFERENCE TO RELATED APPLICATIONS

This application claims the benefit of U.S. Provisional Application No. 63/705,494, filed October 9, 2024, which is hereby incorporated by reference, to the extent that it is not conflicting with the present application.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF INVENTION

### 1. Field of the Invention

The invention relates generally to data management systems, and more particularly to methods and systems for ensuring trust, integrity, and validation of result sets in distributed or decentralized computing environments.

### 2. Description of the Related Art

A Decentralized Physical Infrastructure Network (DePIN) is a type of distributed system that is made up of many independent nodes. Each node may provide physical or virtual resources that enable tasks such as data storage, data management services, computing power or network bandwidth. These nodes may be coordinated using decentralized ledger technologies (e.g., blockchain) which can be used to record service agreements, operational policies, information shared between nodes, enforce operational policies, and track compensation or rewards associated with resource contributions. In the context of the invention, the blockchain may serve to host metadata that is shared by all members of the network.

Because the nodes in a DePIN are operated by independent and potentially untrusted parties who are compensated for providing resources or services, there exists an inherent incentive to maximize rewards while minimizing actual resource utilization. Such incentives may give rise to dishonest or malicious behavior, including but not limited to falsely claiming that data is stored when it is not, returning fabricated or incomplete query results, or otherwise misrepresenting the services performed. If such actions are not reliably detected and penalized, the overall trustworthiness and reliability of the network may be degraded, thereby compromising the integrity of applications and systems that rely on the DePIN.

Currently, there is limited ability to detect and penalize this dishonest behavior.

Decentralized verification of data queries has emerged as an important requirement in environments where multiple parties contribute computing or data resources. Existing approaches generally rely on a prover-verifier architecture, in which a prover executes a query and returns both the query result and a cryptographic proof of correctness. In these models, proofs are generated during query execution by producing commitments over intermediate values of the query plan. A verifier device then checks the correctness of the query result against the returned proof. This approach has several limitations:

Firstly, this approach does not support the full SQL standard and only permits a limited subset of SQL constructs. Second, this style of approach requires modifications to the underlying database system or the creation of new database structures in order to accommodate the proof mechanism. This requirement makes it impractical in heterogeneous environments that are using existing database systems. Lastly, the generation of cryptographic proofs during query execution imposes significant computational overhead, resulting in a substantial slowdown of query performance. This overhead makes the approach unsuitable for time-critical scenarios such as IoT, edge data processing, or real-time operational control.

Accordingly, there exists a need for a verification mechanism that: a) supports the full range of SQL operations; b) functions without requiring modification of existing databases or the creation of new databases; and c) achieves verification without imposing prohibitive performance penalties.

Other solutions primarily focus on verifying that data is stored but offer limited ability to verify that query results returned by data storage or compute nodes are accurate, complete, and consistent with the original data. As a result, data owners and users lack strong assurances that responses reflect the actual state of the underlying data. This gap highlights the need for improved methods that employ zero-trust principles, in order to validate query results, preserve data integrity, and reduce incentives for malicious or non-compliant behavior by operator nodes. Without such safeguards, users who submit queries have limited assurance that the data they receive corresponds to the data originally stored in the network. Improved methods for verifying query results are therefore needed to strengthen trust and reliability in the system.

### BRIEF INVENTION SUMMARY

The present invention addresses the deficiencies of present solutions by providing a mechanism to validate query execution and result sets through file-level hashing, metadata publication, and selective re-execution. The present invention may perform verification as an independent process, after the query execution, and does not disrupt or impact query performance.

In particular, the invention may allow validation to occur transparently alongside existing database operations without requiring any changes to the underlying database process or the creation of a specialized database. Therefore, users can utilize any database of their choice, and there is no need to alter or modify existing database systems.

By leveraging a shared metadata layer within a decentralized physical infrastructure network (DePIN), the system ensures correctness and trust in query results across heterogeneous and distributed data sources. The system may further perform result-set verification independently of the query process, without affecting query execution time and without requiring any modification to the databases or processes that generate the result sets.

This approach achieves efficient verification, supports the full SQL semantics, and enables real-time and near real-time use cases without sacrificing performance or compatibility.

The invention generally relates to data integrity and trust management within decentralized physical infrastructure network (DePIN). A DePIN may include operator nodes that store and manage the data and query nodes that serve to query data using a query process. The nodes are connected by a network that facilitates peer-to-peer (P2P) communication without reliance on centralized intermediaries. In one embodiment, the network protocol is a transmission control protocol (TCP), although other protocols may also be used. Messages exchanged across the network may be cryptographically signed by the sender, such as with the Rivest-Shamir-Adleman (RSA) protocol, to provide verifiable proof of origin and content integrity, such as with the secure sockets layer (SSL) network protocol.

The query process may be satisfied by applying a MapReduce process on target operator nodes. The target operator nodes may be selected based on analysis of the query request to determine the data required for generating a response. The target nodes may be identified using information maintained in a shared metadata layer that operates like a shared metadata storage. In certain embodiments, the shared metadata may be implemented within a blockchain ledger. In other embodiments, the shared metadata may be maintained using a P2P synchronization protocol, such as with a Byzantine Fault-Tolerant (BFT) protocol that may be employed to securely enforce both consistency and serializability across the distributed system.

In some embodiments, the data required to answer a Structured Query Language (SQL) query, may be located by identifying the data table referenced in the SQL query text. Then, by correlating the identified data table with metadata maintained in a shared metadata layer, the operator nodes that host the identified table's data may be located.

In one embodiment, the metadata includes an entry for each operator node and the list of data tables that each operator node supports. Based on the data tables referenced in the query and the metadata which may be hosted in a blockchain, the query process can construct a list of operator nodes that host the data associated with the specified table(s). The nodes that host the data associated with the table, may be referred to as target nodes. Therefore, when a query is submitted to a query node, the query node may determine the target nodes. Through the use of a network protocol, the query node may deliver the query to the target nodes. The target nodes may then execute the query over the data which they manage, and each target node returns a result set to the query node. Each portion of the result set may be derived from applying the delivered query request on the data that is hosted on each target node and is associated with the table specified in the query. The query node may then aggregate all of the returned result sets and generate the complete and unified result set, which may be provided to the requesting user or application.

In a trustless network like a DePIN, nodes may be malicious, and the invention provides the mechanism to identify and penalize malicious operators. In one embodiment, this process is executed as follows:

In one embodiment, a data owner uses DePIN operator nodes to store data. These operator nodes may be selected by the data owner in an auction or a marketplace that considers parameters such as location, Service Level Agreement (SLA) and cost. The data owner may detail the SLA terms needed, the available budget, and any other requirements that are to be considered. The network protocol may filter and present the operator nodes that meet the requirements specified by the data owner. With the information presented, the data owner can select the operators to use. In some embodiments, the selection process is automated. After the data owner selects one or more operator nodes to store the data, the data along with one or more timestamps may be transferred to the selected operator nodes. If a timestamp is not contained in the data or message, a timestamp may be generated. In one embodiment, a timestamp may be generated based on the time that the operator received the data. The data sent to the operator nodes is organized in files, whereas in some embodiments each file is associated with a timestamp. By one embodiment the timestamp represents the time of file creation. In some embodiments, the file includes data received in a time interval, and the time interval is associated with the file. In another embodiment, data received in a time interval is partitioned to multiple files, whereas each file represents data associated with a specific table. These files may be represented by a file identifier (ID) and additional information derived from the files. In some embodiments the file ID may be a hash value of the data contained in the file. Additional information may be associated with each file, such as a derived timestamp or a timestamp from the data contained in the file, the data table(s) associated with the file's data, information extracted from the messages used to deliver the data, a message timestamp, or time ranges associated with the data contained in the file.

The data transferred to each operator node is stored in a database or as files on the operating system or in any other way that allows the operator node to satisfy queries over the data. In some embodiments, rows generated from the source data update a database on an operator node. In such embodiments, the rows may be extended to not just include the data sent over by the data owner, but to additionally include a hash value representing the file from which the row was inserted from. In different embodiments, a file ID may be generated. This file ID may serve as serialization number and reflect the order in which data from the files was inserted into the database. Optionally rows stored in a local database on an operator node may reference the File ID. This process results in a) each file containing a data set derived from one or more data sources, with the files associated with a representative timestamp or time range, as well as additional metadata describing the file; and b) a setup that enables queries over the data. In some embodiments, this setup includes a database and a process for updating the database with the source data.

For each file, a hash value, or an identifier from which the hash value can be derived, together with one or more timestamps and additional information, may be digitally signed by the operator node. This signed message can be published on the shared metadata layer (e.g., a blockchain ledger) or sent to the data owner or both. This signed message may serve as cryptographic and verifiable proof that the operator node is managing the data that generated the hash value.

Upon receipt and/or publishing of the hash value on the shared metadata layer, the data owner may validate that the hash value calculation and the associated timestamps correctly represent the data that was delivered to the operator. This may be done, in some cases, by the data owner locally calculating the hash value(s) on the source data and comparing this calculated value to the published value. This comparison ensures that the source data is complete and unaltered at the time it is first stored on the operator node(s).

Users and applications may issue queries to the network; these queries may include a time range and are provided to the query nodes that orchestrate the query process. In one embodiment, these queries utilize SQL, although other query languages or formats may also be used.

In some cases, when a query is provided to a query node, the query node may forward the request to one or more operator nodes that host the relevant data, whereas said operator nodes are the target nodes identified by the process of associating the information contained in the query with the information contained in the shared metadata. The query message may be signed by the query node with the list of target nodes. The query message may additionally comprise a timestamp representing the query issuance time. This signed message may be published on the shared metadata layer (e.g., blockchain) to serve as verifiable proof that the target nodes are being requested to process the query.

When target nodes receive a query, they may process the query and return a result set to the query node. Said result set returned by each operator node is the result of processing the query over the data hosted by the operator. In some embodiments, the result set may be sent in a JSON format and may be extended to include the query text or an identifier of the query text. In some embodiments, the identifier may be a hash value computed from some or all of the query text. The target nodes may return for each query a signed result set that includes a file identifier. The signed result set may serve as proof that the query was executed by the operator node, and that the operator node generated the included result set. The file identifier may represent the most recent file processed by the operator and serve to identify the database state at the time the query was executed. For each query, the target nodes may generate and return a digitally signed result set that includes a file identifier. The signed result set may serve as cryptographic proof that the query was executed by the operator node and that the operator node generated the corresponding result set. The file identifier may further serve to identify the state of the database at the time the query was executed.

For a given query, users and applications may decide to validate the result set returned by an operator. The query issuing the result set may be referred to and the contested query and the result set returned by the operator may subsequently be referred to as the tested set and it may be validated by a mediator node. A mediator node validating a tested set may utilize the following process:

Based on the query time range, a mediator node may retrieve from the shared metadata layer all hash values or file identifiers associated with data sets containing the source data whose timestamps or time ranges overlap with the specified query time range.. In some embodiments, the mediator node may restrict its collection to file identifiers recorded on the shared metadata layer that corresponds to data present in the database at, or before, the database state associated with the tested set. This step enables identification of the source data which was verifiably acknowledged by the operator as processed data, at the time of the query, and therefore, if correctly applied to the query process, would generate a valid result set.

The mediator node may then proceed to retrieve the source data by requesting each file by its hash value from the operator that previously published the hash on the shared metadata layer.

The mediator node may then independently calculate the hash value of each received file. The mediator node may then compare this calculated hash value to the hash value that was originally posted by the operator to the shared metadata layer when the data was originally stored. If the hash value calculated by the mediator is different than the hash value published by the operator, the mediator may announce that the operator fails to satisfy the service.

If a hash value calculated by the mediator node does not match the corresponding hash value previously published by the operator node to the shared metadata layer, the mediator node may conclude that the operator node is acting in a malicious or non-compliant manner. In such cases, a penalty may be imposed on the operator node.

In the event that the hash value calculated by the mediator node is the same as the value published by the operator node in the shared metadata layer, the mediator node may proceed with the result set validation process.

After confirming that the contents of the received source data files are complete and correspond to the files used in the calculation of the originally published hash values, such as by comparing the hash of the received file to the published hash in the metadata layer, the mediator node may execute the query on the verified source data. In some embodiments, execution of the query and validation of the result set may be performed by inserting the source data into a local database managed by the mediator node and re-issue the contested query over the data. If multiple operators participate in the query process, the validation process may be repeated for each operator, with the mediator validating the data set managed by the respective operator under test.

Executing the query locally by the mediator results in the generation of a validating set. The hash value of the validating set may be compared to the published hash value of the tested set to determine the correctness of the tested set.

In the event that the validating set does not match the tested set, the mediator node may conclude that one or more of the operator nodes that produced the tested set are malicious. In such cases, where one or more of the operator nodes are determined to be malicious, a penalty may be imposed on the operator node.

If a mediator determines that a requested validation process does not show a malicious behavior, a penalty may be imposed on the users and/or applications and/or nodes that incorrectly and/or persistently accuse operator nodes of malicious behavior.

In some embodiments, a penalty mechanism may be implemented through a smart contract; said smart contract may be deployed on a blockchain platform.

Optionally, data within the DePIN may remain private using a secret-sharing process.

In some embodiments, a smart contract may penalize a malicious node by confiscating a portion or all of the staked tokens that were required to participate as an operator node. The confiscated tokens may be distributed to the contesting participants, honest nodes or burned to reduce the malicious node's influence in the system. In other embodiments the operator node may be blacklisted or temporarily banned from participating in the network.

In some embodiments, the network processes may include a public notification event (PNE). A PNE is a process by which a node in the network publishes a digitally signed event to the blockchain, thereby making the event publicly known. The signed event may serve as cryptographic proof of the existence of the event and may include details describing the event. In other embodiments, a PNE may function as a notification of an on-chain blockchain transaction. In further embodiments, PNEs may be used to record or announce the issuance of a query, the return of a query result set, validation outcomes, penalties, or confirmations of query results, thereby supporting a zero-trust framework in which network events are verifiable and publicly auditable.

In some cases, parties to a smart contract may give up the right to claim that published PNE or signed event messages were not delivered to them.

In such cases, a PNE can publish a message that details the issuance of a query request to specific target operator nodes. If the query request sent to one or more target nodes which are signees of a smart contract, is not replied to, such nodes may be penalized. In such cases the PNE may serve as proof the query request was issued to the target nodes.

In some embodiments, when a query node does not receive a reply to a query, the query node may publish a PNE with the query details and the target operators. Each operator node may publish the result set and a hash value representing the returned result set. The hash value may itself be published as a PNE by the operator node. Such a PNE may serve as proof that a reply was provided whereas its absence is proof that a reply was not provided. In the context of the invention, PNEs are treated as metadata information recorded within the shared metadata layer. Such PNEs may be published, discovered, and explored by other nodes through queries to the shared metadata.

In some embodiments, PNEs may be used as proof that a file has been requested from an operator node. In other embodiments, PNEs may be used as proof that a response has been returned by an operator node to a query node. More broadly, the PNE mechanism may incentivize parties within a DePIN to interact honestly, since ignoring requests or failing to provide responses may result in the need to publish corresponding evidence to the shared metadata layer and may further lead to the enforcement of penalties. Accordingly, participants may be motivated to comply with protocol requirements in order to avoid the reputational and economic costs associated with adverse PNEs.

In some embodiments, query nodes may be integrated into the applications that issue queries or may be operated by entities owned or trusted by the query issuers. In certain embodiments, query nodes may be stateless, representing a process invoked by the user or application when data is requested. Because of this stateless nature, users or applications may establish trust in the query nodes dynamically, without the need for special or time-consuming initialization procedures. In this manner, a query node may function as an extension of the user or application that issues the query, enabling users and applications to trust the query nodes they employ.

In one embodiment, the query process and the query validation process are included in the network protocol.

In some portions of the discussion of this invention and application, the phrases “blockchain”, “shared metadata”, “shared metadata layer” and “metadata layer” are used interchangeably. The key components of blockchain and shared metadata are that transactions can be authenticated, serialized, immutable, verifiable, and available to all nodes interacting with the network.

### BREIF DESCRIPTION OF THE DRAWINGS

For exemplification purposes, and not for limitation purposes, aspects, embodiments or examples of the invention are illustrated in the figures of the accompanying drawings, in which:

FIG. 1 illustrates three (3) exemplary data sets that may be stored in a DePIN.

FIG. 2 illustrates exemplary hash values, file identifiers and time ranges published by an operator on the shared metadata layer.

FIG. 3 illustrates an exemplary result set returned by an operator node to a query of a query node.

FIG. 4 illustrates an exemplary hash value of a query with a hash value of the returned result set.

FIG. 5 illustrates a block diagram of decentralized physical infrastructure network, according to an aspect.

FIG. 6 illustrates an exemplary software and hardware stack of an operator node within a decentralized physical infrastructure network.

FIG. 7 is a block diagram illustrating an embodiment of a shared metadata layer.

FIG. 8 is a flowchart illustrating one embodiment of the method of validating result sets.

FIG. 9 is a flowchart illustrating an exemplary method of storing data within a DePIN.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

It should be understood that, for clarity of the drawings and of the specification, some or all details about some structural components or steps that are known in the art are not shown or described if they are not necessary for the invention to be understood by one of ordinary skills in the art.

A DePIN system is an open network, where network operators can be individuals or entities whose identities can be either known or unknown. Network operators may sell their computing and storage resources. Data owners may pay for the data services offered by the operators. In a DePIN system, network operators provide data services, such as storage or computation through a decentralized and open marketplace. The marketplace may be used by data owners who want to send or stream time-series data to endpoints provided by network operators. Data owners can issue query requests on the stored data and network operators are expected to service and return result sets based on those requests.

During the query result set validation process, the time range specified in the query serves as a primary selection criterion for identifying source files that may contain data which need be considered to satisfy the query. The process correlates the query's time range with the time range assigned to source files maintained by operator nodes. A file may have an assigned time range determined in at least two ways: (i) from timestamps embedded in the data records within the file, or (ii) from an ingestion timestamp recorded when the file was introduced into the system.

Using this correlation, the validation process determines whether a file is relevant to the query. If the query's requested time range overlaps with the file's assigned time range, the file is selected for further processing. This approach enables efficient identification of candidate files without considering unrelated files, thereby reducing processing overhead and improving query responsiveness. Additional selection criteria may also be applied, for example, a query may target a specific table, and that table may in turn be mapped to one or more files for validation.

Once the candidate files are identified, the validation process may load the selected files into a database and re-execute the query. The resulting data set is then hashed, and the computed hash is compared with the hash value of the result set previously published by the operator. A match confirms the integrity and correctness of the operator-provided query result.

A mediator node may execute the validation process when a query result set is contested. The mediator may orchestrate the retrieval of source files within the relevant time range from the operator nodes, loads the files into a local database, and re-executes the query to independently reproduce the result set. A mediator is sometimes referred to as a validator.

An operator node may be added to the network by publishing a policy that identifies the node in the network including the IP and port or other information that allows communication with the node. This policy or other policies are updated to reflect the data serviced on the node. For example, an operator may publish a policy that states that it is hosting data from a table named “ping_sensor”. When a query is issued to evaluate data from the table “ping_sensor,” the query process identifies one or more operator nodes that host the relevant data. The query node obtains the IP addresses and ports of those operator nodes from the shared metadata policies that publish node connection details. These policies are maintained on the blockchain, ensuring that connection information is securely stored and globally accessible to all network participants. Using this information, the query node communicates with the identified operator nodes, transmits the query for execution, and aggregates the individual responses into a unified result set that is returned to the query issuer or to a designated set of recipient nodes.

Policies published by operator nodes may include Service Level Agreement (SLA) guarantees. These guarantees enable data owners or the network protocol to identify and select operators for data hosting based on specific SLA requirements. Policies published by operators can include a price list for the services they provide. Data owners or the network protocol can identify and select operators by the price of the service that they require. Policies published by operators can include penalties for malicious behavior. Data owners can identify and select operators by the penalties. For a data owner, the penalties guarantee compensation if the operator acts maliciously. The penalty mitigates a service by an untrusted operator. Additionally, the policies might include penalties for the data owner or a query node for falsely initiating a validation process that incurs the operator additional costs. Penalties may be embedded in smart contracts to ensure compliance, fairness, and trust as smart contracts are self-executing, so penalties for non-compliance are automatically enforced when certain conditions are violated. This eliminates the need for third-party enforcement (e.g., courts, arbitration), ensuring that all parties are bound by the contract's rules. In a particular embodiment, rewards for compliance are automatically awarded when certain conditions are satisfied.

Data hosted by operators may be time series data organized as log files. The organization of log files can be done by the data owner, or by the operator. In one embodiment, the data is stored in a database where each row includes the identifier of the source file from which the row was derived, along with the sequence number of that record within the file. This arrangement allows the operator to reconstruct an entire source file by executing a query that retrieves rows by file identifier and orders them by sequence number. In another embodiment, the source files are maintained in an archive and can be supplied directly upon request.

A source file can be organized as a log file with time series data records, system events or activities alongside corresponding timestamps, making it a collection of data over time. In this context, each log entry is associated with a specific time point, allowing for the tracking and analysis of trends, performance, and anomalies across the system or application by time. This type of log file is particularly useful for monitoring long-term behavior and troubleshooting issues, as it provides precise timing for each event.

For example, in an IoT system, a log file could store time-stamped data from sensors, such as temperature readings, system alerts, or network activity. This allows administrators or analysts to query the data over specific time ranges, detect patterns, or diagnose problems based on when events occurred.

Time series log files are integral to various applications, such as system monitoring which logs CPU usage or memory consumption over time, IoT devices which capture environmental sensor readings (e.g., temperature, humidity) in a time-stamped format, and security logs which track login attempts or security incidents with precise timestamps for auditing and analysis.

Operator nodes may receive data from one or more data sources. The incoming data may be provided as complete log files or as individual time-series events that the operator organizes into one or more log files. The organized data is then ingested into a database or stored as files on the operating system, or by any other method that enables the operator to satisfy query requests.

If the incoming data is not already in a log-file format as time-series data with timestamps, the operator node may first reorganize it into a log file containing appropriate timestamps. The operator then calculates a hash value for each file to ensure integrity. The resulting data file is subsequently placed in storage and may also be ingested into a database, depending on the system configuration.

The hash value, file identifier, and timestamp or time range associated with the data in the file, as well as additional information, may then be signed and published on the shared metadata layer. In one implementation these publications may be hosted in a blockchain, and in another implementation may be hosted in a DBMS. This process may be included in the network protocol. Said publication allows for the identification of files by time ranges, and in some implementations, the filtering of files by criteria, for example, by the table assigned to the data contained in each file(s).

In some embodiments, a method for improving trust in a decentralized physical infrastructure network (DePIN), may be executed on a network of nodes. Each node may include at least one computer system comprising at least one processor, a memory, and a computer program with processor-executable instructions stored on a non-transitory processor-readable medium.

Broadly speaking, the method for improving trust may include the following steps. First a mediator node may obtain a result set associated with source data and a query/request. The mediator node may then identify and obtain data files associated with the source data. The mediator node may verify that the data files are complete and have not been tampered with by calculating a hash value for each data file (“validating hash value”) and comparing these hash values to corresponding hash values previously published onto the shared metadata layer at the time of data storage by the operator node (“original hash value”). Lastly, the mediator node may validate the result set by executing the query on the verified source data contained in the verified data files to generate a validating set. The mediator node may then determine the correctness of the result set by comparing the result set with the validating set. In another embodiment, the mediator node may determine the correctness of the result set by comparing a representative of the result set with a representative of the validating set.

More specifically, the method for improving trust may include the following steps. First an operator node may receive input data from a data source owned by a data owner. The data owner may confirm that the operator node has properly stored all of the input data by comparing one or more hash values published by the operator node to the shared metadata layer (“original hash values”) with hash values calculated by the data owner (“new hash values”). Later on, a query validation request may be submitted, and a mediator node may obtain a result set or a representative of a result set which may be associated with the input data and a query. The mediator node may then identify one or more data files which contain the input data and are associated with the result set or the representative of the result set. The mediator node may then request and receive the data files from an operator node. The mediator node may then validate that the received data files are complete and have not been tampered with by calculated a hash value (“validating hash value”) and comparing this to the hash values published by the operator node at the time of data storage (“original hash value”). Once the mediator node has confirmed that the data is complete and has not been tampered with, the mediator node may validate the result set. The mediator node may evaluate the result set by executing the query on the verified input data to create a validating set. This validating set may be compared to the result set, in order to determine the correctness of the result set. In other embodiments the mediator node may validate the result set by comparing a representative of the result set with a representative of the validating set. In another embodiment the mediator node may determine the correctness of the result set by comparing a hash value of the result set with a hash value of the validating set.

In some embodiments, operator nodes may be penalized for acting maliciously. In some embodiments, operator nodes may be penalized when the original hash value(s) are not equal to the new hash value(s), when the original hash value(s) are not equal to the validating hash value(s), or when the result set is determined to be incorrect.

As previously stated, in some embodiments, the method may be executed without disrupting the computing processes or altering the source data stored on the operator nodes that generated the result set received by the client device. In other words, the result set validation method may be performed without disrupting computing processes of the operator node which produced the result set, or the representative of the result set. The result set validation method may also be performed without altering any data files, source data or databases stored on the operator nodes which produced the result set or representative of the result set. The initial result set may be generated on a database that does not participate in the result set validation process.

The invention may allow validation to occur transparently alongside existing database operations without requiring any changes to the underlying database process or the creation of a specialized database for use in the validation process. Therefore, users can utilize any database of their choice, and there is no need to alter or modify existing database systems.

Executing the method independently of query execution also avoids any increase in query execution time (i.e., the time between a user issuing a query and receiving a result). In some embodiments, one or more validation steps, including execution of the validation method, calculation of the validating hash, and re-execution of the query by the validator, may be processed on a compute node that is different from the node or nodes that processed the query..

The following figure descriptions further exemplify the processes of the invention:

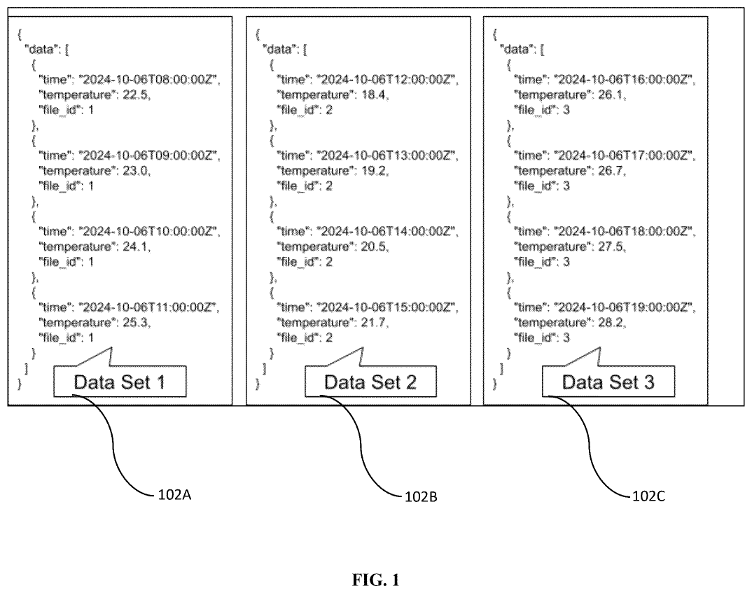

FIG. 1 illustrates three (3) exemplary data sets that may be stored in a DePIN. FIG. 1 is an example of data generated from edge devices. As shown, the data is organized as three (3) separate JSON files. Each file includes multiple readings, with each reading includes three (3) attribute values including a timestamp temperature reading, and file identifier. Data sets, such as the data sets 102A-C illustrated in FIG. 1 may be organized by data owners and transmitted to an operator node. In another embodiment, the individual readings may be provided to an operator node. In such cases, the operator may organize these data readings into files. In some embodiments, operators may organize readings into files according to defined data ingestion rules. Exemplary data ingestion rules include a rule that determines that every 4 readings are organized in a file, or every 4 seconds of data transmitted is organized in a file or in any other way. In some embodiments, an operator node may enforce a rule that all data entries contained within a given file are associated with a single logical table. This constraint simplifies indexing, validation, and query resolution by ensuring that each file corresponds to a distinct table. For example, as illustrated in FIG. 1, Data Sets 1-3 may be associated with Tables A-C, respectively, such that all records in Data Set 1 map to Table A, all records in Data Set 2 map to Table B, and all records in Data Set 3 map to Table C. This file-to-table association facilitates consistent metadata assignment and validation and prevents errors or ambiguities when operator nodes respond to queries. In this case, the published information for each file is extended by the table assigned to the file whereas said table can be used to filter the relevant files that need to be considered in a validation process. This extended information includes the identification of the operator that is hosting the file's data.

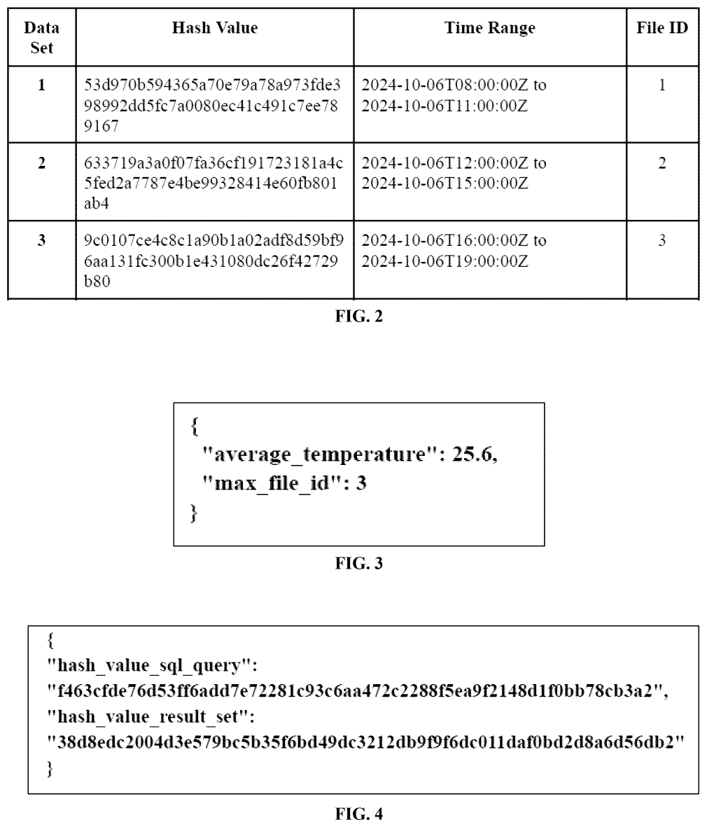

FIG. 2 illustrates exemplary hash values, file identifiers and time ranges published by an operator on the shared metadata layer. FIG. 2 demonstrates one embodiment of metadata that may be published by an operator node on the shared metadata layer. Said metadata may be used to identify each source data file by its hash value and may include the data set time range. Optionally, a map of hash values to file identifiers that represent a serialization of the order the files were inserted into the database may also exist. Such a map of hash values may be used to identify the database state at the time the query was executed. Each published entry may be signed by an operator node (not shown) to serve as proof that the file is managed by the signing operator node.

Using the published metadata, data owners are capable of validating that their data was received by the operator node. In some embodiments, the data owner may transfer the data to the operator as data sets organized in files. In such cases data owners may pre-compute the hash value and the time range for each file and compare the computed values to the values published by the operator on the shared metadata. Through this precomputation and/or verification of the hash value published by operator node(s) at the time of data insertion, data owners may verify that all of their source data is recognized by the operator and properly stored.

In some embodiments, each file's data is ingested to a SQL database on the local node. Examples of such databases are PostgreSQL, SQLite, Oracle, and SQL Server. In a specific implementation the databases are managed by a decentralized platform provided by AnyLog or using the Linux Foundation project EdgeLake. The process of mapping the source data to SQL inserts can use a mapping scheme. For example, if the source data is in JSON format, the mapping can consider the attribute names as the column names and the attribute values as the column values.

Query nodes satisfy query requests from users or applications by identifying the operator nodes that host the data that need to be evaluated to satisfy the query and orchestrating the query process. Said operator nodes are the target nodes and in the query process, the query node delivers the query to the target nodes. The target nodes process the query on the data sets they manage and return a result set to the query node. The result sets from all the participating operators are aggregated by the query node and a unified result is returned to the issuer of the query.

FIG. 3 illustrates an exemplary result set returned by an operator node to a query of a query node.

As shown, the figure displays a result set to a query issued to an operator node for the average temperature between 2024-10-06T14:00:00Z to 2024-10-06T19:00:00Z together with the Max File ID processed. Assuming the Max File ID is represented in the table processed, said query is in SQL and is follows: ‘SELECT AVG(temperature) as average_temperature, MAX(file_id) as max_file_id FROM temperatures WHERE timestamp BETWEEN ‘2024-10-06T14:00:00Z’ AND ‘2024-10-06T19:00:00Z’; alternatively, the “max_file_id” is managed by the operator node and is added by the Operator node to the result set returned by the SQL query.

A signed query may be sent to an operator node and in some embodiments, a query node may use a PNE process and publish the signed query and the target operator on the blockchain.

Assuming data sets 1-3 of FIG. 1 are assigned to table “temperatures”, a correct reply to the query text outlined above needs to consider data set 2 and 3 shown in FIG. 1 as follows:

From dataset 2, an operator node must locate the third listed record which at a timestamp of 2024-10-06T14:00:00Z recorded a temperature of 20.5° C.

Additionally, from dataset 3, an operator node must locate all of the readings contained in dataset 3 which read a temperature of 26.1° C. at a timestamp of 2024-10-06T16:00:00Z, a temperature of 26.7° C. at a timestamp of 2024-10-06T17:00:00Z, a temperature of 27.5° C. at a timestamp of 2024-10-06T18:00:00Z, and finally a temperature of 28.2° C. at a timestamp of 2024-10-06T19:00:00Z.

Using the readings mentioned above, the operator node should calculate the average temperatures as follows: 128.0/5=25.6° C. This value is shown is FIG. 3 as ‘“average_temperature”: 25.6’.

Additionally, the reply may include the most recent file identifier at the time the query is executed. As shown in FIG. 3, the most recent file identifier from the datasets shown in FIGS. 1 and 2 is “file_id”: 3. As shown in FIG. 3, the most recent file identifier is listed as “max_file_id”: 3. The inclusion of the most recent file identifier specifies the database state at the time of query execution. In this example, it would be all files with File ID 3 or less.

Operator nodes may process the query (e.g., an SQL query) on the local database to generate a result set (e.g., JSON) which may, for example, allow for the calculation of a metric such as the average temperature.

FIG. 4 illustrates an exemplary hash value of a query, and a hash value of the returned result set. After executing the query, the operator node may calculate a hash value for both the query and the result set. As shown, the hash value for the SQL query above is “f463cfde76d53ﬀ6add7e72281c93c6aa472c2288f5ea9f2148d1f0bb78cb3a2” and the hash value for the result set is “38d8edc2004d3e579bc5b35f6bd49dc3212db9f9f6dc011daf0bd2d8a6d56db2”

In some embodiments, the operator node may reply with a signed message of both hash values. In other embodiments, the information of FIGS. 3 and 4 may be represented as a PNE event on the shared metadata layer (e.g., blockchain).

A result set validation process of the invention is able to identify a correct result set and may include the following steps:

A mediator node may retrieve from the shared metadata the hash values of the files that correspond to the time range in the query. The mediator may request the files'data from the operators that host the files.

In one example, the hash values of data sets 2 and 3 are retrieved. The mediator node may then request from the operator node the files that are associated with the identified hash values. A hash value of “633719a3a0f07fa36cf191723181a4c5fed2a7787e4be99328414e60fb801ab4” may represent data set 2 from FIG. 1, and a hash value of “9c0107ce4c8c1a90b1a02adf8d59bf96aa131fc300b1e431080dc26f42729b80” may represent data set 3 from FIG. 1.

For each file received from the operator, the mediator node may recalculate the hash value, to determine that the file is complete.

Once it has been confirmed that the source data files received are complete, the mediator node may execute the query on the received source data. In some embodiments the mediator node may load the source data into a local database or DBMS to execute the query. In some cases, the query may be an SQL query.

The mediator node may then organize its calculated result set, the validating set, into a file structure. In some embodiments this file structure is JSON. In the process of the invention, the file structure matches the file structure of the result set provided by the operator node to the query node.

The mediator node may then calculate the hash value of the validating set and compare this calculated hash value to the hash value previously published by the operator node on the shared metadata layer at the time of data insertion. FIG. 4 illustrates exemplary hash values. If the hash value of the validating set and the tested set are the same, the tested set is deemed correct and the operator node(s) hosting the source data, as honest.

In some embodiments, messages may be delivered or published to the blockchain using a secret-sharing process. Said processes including the validation process and the secret-sharing process may be embedded in the network protocol.

The validation process of the invention is able to identify the source data that needs to be evaluated to satisfy the query and repeat the query to generate a result set that is compared with the result set that needs to be validated. If the two result sets are identical, or if their hash values are identical, the result set returned by the operator is a correct result set. If they differ, the result set returned by the operator is not correct, and the operator node(s) may be deemed malicious.

When a MapReduce process is used, the query is issued to multiple operator nodes and the result sets returned from all participating operators are aggregated to a unified result set. With multiple operators, the validation process is executed against each operator independently. The query used in the validation process is the same query that was originally processed by the operator node. The result set being validated is the result set returned by the operator node in response to that original query. The data sets used for validation comprise the source data managed by the operator node being validated and are used by the mediator node to re-execute the query and verify the correctness of the result set which was delivered by the validated operator to the query node.

Using this process, a data owner and query nodes may track the data hosted and managed by each operator node. In addition, the query protocol is extended to satisfy requests for files containing source data managed by each operator by using either hash values or file identifiers.

Said network protocol is further extended by a validation process. The validation process may identify file identifiers, their hash values, and the corresponding operator nodes hosting the data by reference to the time range specified in the query, optionally combined with additional filtering criteria. In one embodiment, the filtering criteria may include the table name or names associated with the data contained in each file. The validation process may then request the identified files from each operator using the file identifiers. Once the files are received, the content of each file may be validated by recalculating a hash value over the file and comparing the recalculated hash value to the published hash value stored in the shared metadata. In some embodiments, the validation process may further re-issue the original query against the validated files'data and compare the resulting output to the result set returned by the operator nodes. In this manner, the validation process can confirm both the integrity of the underlying data and the correctness of the query execution. Discrepancies between the validated query result and the operator-supplied result can be detected and flagged, thereby ensuring that operator nodes cannot falsify, omit, or alter data or result sets without detection.

The following paragraphs discuss one embodiment of a mediation approach.

In one embodiment, a data owner or a query node may test if an operator is malicious by showing that the network operator fails to provide a correct result set. This embodiment requests within the DePIN system for a set of mediators to validate the correctness of the result set using the operator attested result set, file identifier and the issued query.

The following is an example of a mediation process; said mediation is embedded in a Smart Contract that operates with the following steps:

A data owner may provide a signed attestation to the mediator or set of mediators; the issued query, an operator's attestation of the executed query, the returned result set (tested set), and the file identifier(s). In some embodiment, the attestation of the executed query is the hash value of the result set that was published by the operator on the shared metadata.

Each mediator node may then request from the operator node(s) all the data file(s) based on the file identifier(s). Additionally, the operator attested file identifier, with the file timestamps and the query timestamp may allow mediator to identify the database state at the query execution time.

Each mediator node may dynamically spawn a database and insert the data from all of the retrieved files. Each mediator node may then execute the query requested by the data owner and may return a result set, the validating set (also validated set or validation set).

Each mediator node may then conclude whether or not the tested set and validating sets match and depending on the conclusion may cast a vote on whether the operator node is malicious or not. If the operator node is determined to be malicious, the owner of the operator node may be penalized. In some cases, where the tested set does accurately match the validating set, where the operator node is found to be honest, the data owner or entity that initiated the validation process may be penalized. For example, the data owner may be forced to pay a penalty which can include but is not limited to the cost of the mediation and a fee to the operator. If the tested set does not match the validated set, the mediators may charge the operator a penalty. Once again, this penalty may include but is not limited to compensation to the data owner and the cost of the mediation. In some embodiments, the losing party in the mediation can request a new mediation process, which may include a voting procedure among mediators to determine the outcome of the renewed mediation.

In some embodiments, the mediation process is requested by a user or application that issued the query which is not the data owner. In other embodiments, messages are sent between nodes using a secret-sharing process.

In some embodiments, query execution is validated by considering the database state, the contents of files. Operators may attest to the files they receive and the file contents they inserted into the database via the file identifier. This allows the determination of the database state at the time the query is executed. This allows mediators, or any other node, to identify the needed data based on the files the query was executed on. Thus, mediators can request the files from the operator, dynamically generate a duplicate database instance or limit the data in the created database to the data that needs to be considered using a time range criteria and the table name associated with the data, and validate the result set. In this way, malicious network operators may be identified because network mediators can always spawn a copy of the database with the data the operator executed the query on.

The following paragraphs contain a mediation example between a data owner and an operator.

In a DePIN network, data operators offer both data storage and querying services. Data owners may enter a relationship with the service providers where data owners send data to a set of endpoints provided by the service provider. Data owners may also, at any time, issue query requests on the data the provider stores. One method in which the provider stores the file data can be via a SQL database, but any data storage method in which queries can be executed and result sets on the stored data can be serviced are applicable.

When the operator receives a data file, or raw data batched into a file, the operator may insert the data into a local database and may record the file's metadata information. In some embodiments, the operator may insert the metadata into a smart contract hosted on the shared metadata layer (e.g., blockchain) or attest through a state channel that the data from the file was inserted into a local database and assigning the file a file identifier that represents the serialization of files inserted into the database.

When a data owner submits a query, the operator executes it against the database and may return three (3) elements: the result set, the query text (e.g., raw SQL, a hash of the query, another format that allows for the determination of the query text), and the file identifier.

Mediators seeking to validate the result set provided by the operator may use the file identifier provided in the result set to identify a list of files to request from the operator. If the operator cannot supply all the requested files, or if the hash of a file provided to the mediator by the operator does not match the expected hash, it may be concluded that the operator node is malicious. In the case that the operator node is determined to be malicious, the mediators may initiate a penalty against the operator. In the case that the mediators receive all the requested files, they may reconstruct the database, load the data, and execute the query. If the result set produced by the mediator, the validating set, matches the result set attested to by the operator, a penalty may be imposed on the data owner.

This process validates the integrity of a result set provided by an operator for time-series data in a trustless environment.

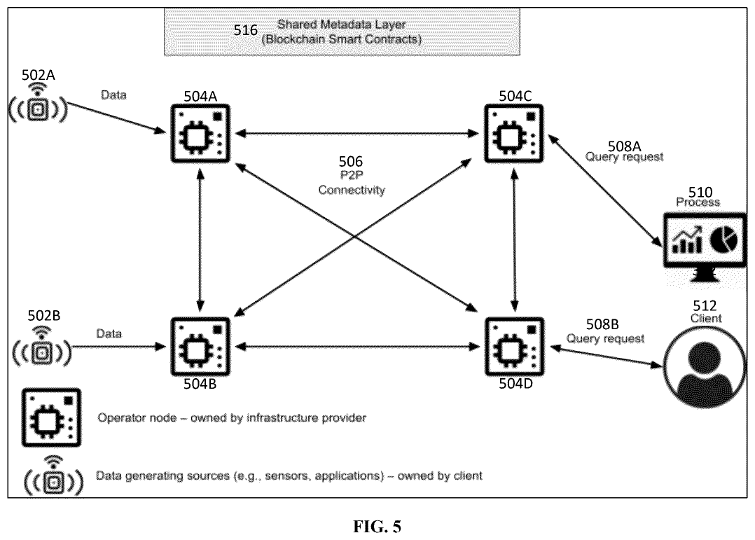

FIG. 5 illustrates a block diagram of decentralized physical infrastructure network, according to an aspect. Data-generating sources 502A and 502B may include Internet of Things (IoT) devices, edge data-generating devices, sensors, or any other data-producing hardware located at or near the network edge. The data-generating sources 502A-502B may produce data in the form of time series data or other structured data formats. This data may be transmitted to and stored on operator nodes 504A-504D that participate in the DePIN.

The operator nodes 504A-504D may be computing devices such as servers, gateways, or embedded systems, each having processing, memory, and storage resources sufficient to perform data ingestion, storage, and query processing functions. Each operator node may store local datasets derived from the data produced by the data-generating sources 502A-502B.

In some embodiments, data owners may encrypt data before transferring it to operator node. This encryption may be done to prevent interception or unauthorized access during the data transfer process or while the data is stored. Examples of encryption methods include but are not limited to symmetric key encryption (e.g., AES), public-key encryption, or secret sharing schemes.

Upon receiving new data, an operator node may compute a cryptographic hash of the received content and generate a data archive policy to register the data with the shared metadata layer 516. A data archive policy may specify the filename, the computed file hash, and an ontology describing the content including the earliest and latest timestamps, the source of the data, and descriptive attributes. A data archive policy may also specify the physical or logical storage location identifying which operator node stores the file, and a digitally signed attestation by the operator authenticating the policy. This process ensures that all data ingested by operator nodes is verifiably indexed and discoverable across the DePIN.

A peer-to-peer (P2P) connectivity layer 506 may connect each of the operator nodes 504A-504D within the DePIN. The P2P connectivity 506 may be implemented using any type of peer-to-peer networking protocol that allows the nodes to directly communicate, share metadata, exchange data blocks, and coordinate query execution. Examples of peer-to-peer networking technologies that may be used include transmission control protocol (TCP), UDP (User Datagram Protocol), Cellular protocols (4G, 5G, LTE-M, NB-IoT), Overlay and peer-to-peer protocols (libp2p, Kademlia, BitTorrent-style DHTs), Secure tunneling protocols (TLS, VPN, WireGuard). More generally, the DePIN may leverage any networking protocol—existing or future—that supports reliable identification of nodes, exchange of metadata, and delivery of queries and results across a distributed environment.

Query requests 508A and 508B may be issued to the DePIN by a process 510 or by a client 512. Process 510 may be an automated program, task, or service that periodically requests data from the operator nodes 504A-504D to update a local dataset, refresh an analytical model, provide monitoring, provide predictive maintenance, provide data for an AI process or trigger automated workflows. Client 512 may be an individual user, application, or external entity that submits on-demand queries to retrieve data stored across the DePIN. Both process 510 and client 512 may transmit query requests 508A-508B to the operator nodes through the P2P connectivity 506.

Peer-to-peer connectivity 506 allows for decentralized coordination of data storage, replication, and retrieval, and enables each operator node to participate equally in the network without relying on a centralized controller. In certain embodiments, P2P layer 506 may also facilitate cryptographic authentication, signed attestations, and secure key exchange between nodes to maintain the integrity and trustworthiness of the network.

Using the diagram of FIG. 5, one embodiment of a query process from application 510 may follow the following steps: The query may first be transferred to node 504C. Node 504C may parse the query and determine the table or tables referenced therein. Based on this determination, node 504C may issue a process to the shared metadata layer 516 to identify operator nodes that host the relevant table data. If nodes 504A and 504B are identified as hosting portions of the referenced table, node 504C may transmit sub-queries or data requests to nodes 504A and 504B accordingly. Nodes 504A and 504B may then retrieve the requested data from their local storage, process the query and return corresponding result to node 504C. Lastly, Node 504C may aggregate the separate result from nodes 504A and 504B into a unified result set and return the result to application 510.

In some embodiments, the query process of FIG. 5 may be extended with a validation process to ensure both the integrity of the source files and the correctness of the query results. An example validation process may proceed as follows: After node 504C receives replies from nodes 504A and 504B and aggregates them into a unified result set, a mediator or validation node may consult the shared metadata layer 516 to retrieve the file identifiers and the corresponding published hash values associated with the tables and time ranges referenced in the query. The validation node may request the identified files from operator nodes 504A and 504B. For each file received, the validation node recalculates a hash value and compares it against the published hash value stored in the shared metadata layer 516. A match confirms that the file has not been altered and was correctly used in query processing. Once the files are verified, the validation node may re-execute the query locally, twice, testing each operator 504A and B separately, against the validated files from each operator to produce a tested result set. A hash value of the tested result set is then calculated. The validation process compares the hash value of the tested result set with the hash value of the result set originally returned by each of the nodes 504A and B. If the values match, the correctness of the operator-supplied result set is validated. If discrepancies arise—such as mismatched result set hashes, missing file coverage, or incorrect operator responses—the validation process may flag the operator nodes responsible and, in some embodiments, enforce penalties, require proof publication to the shared metadata layer, or trigger re-execution of the query by additional nodes.

In some embodiments, to reduce bandwidth consumption, operator nodes may transmit only the hash of the result set rather than the full result set itself. The validation node, after re-executing the query on validated files, can compare the hash of its locally generated result set against the operator-supplied hash. A match confirms correctness, while a mismatch reveals a discrepancy without requiring full result transmission. This approach is particularly advantageous for large queries, high-volume time-series data, or scenarios where result sets are too large for efficient network transfer.

Because query nodes are stateless and may be instantiated by applications or users within their trusted environment, the validation process can be initiated and controlled directly by the query initiator. This ensures that users can independently validate both the integrity of the data files and the correctness of the query results, while maintaining scalability across distributed and bandwidth-constrained networks.

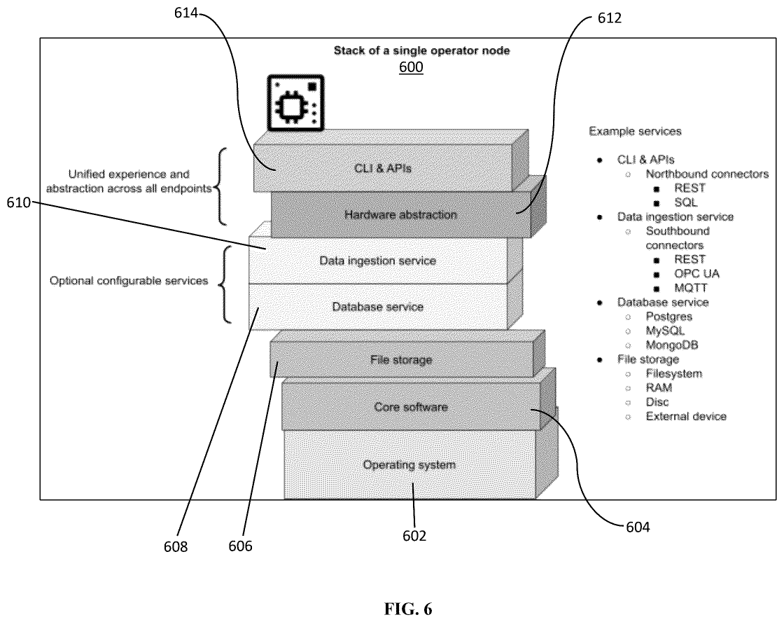

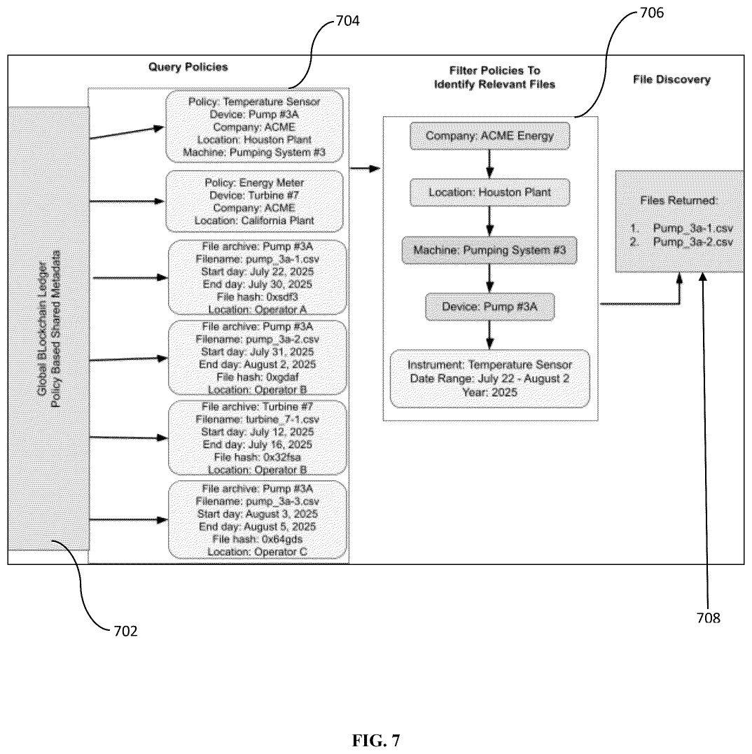

FIG. 6 illustrates an exemplary software and hardware stack of an operator node within a decentralized physical infrastructure network. As shown, operator node 600 includes multiple functional layers that collectively enable the node to ingest, store, and serve data as well as respond to user queries and participate in the validation process.

Operating system 602 may provide the underlying execution environment and resource management for operator node 600. Operating system 602 may include kernel-level services and device drivers for managing processors, memory, storage and network resources and may be implemented using a general-purpose operating system such as Linux or Windows, or an embedded or real-time operating system.

Core software 604 executes on top of operating system 602 and implements the primary logic required for participating in the decentralized network. Core software 604 may coordinate node operations, communication with other nodes, may publish and retrieve metadata, and may perform cryptographic signing and verification of data. Core software 604 may ensure that data managed by operator node 600 remains verifiable.

File storage 606 may provide persistent or temporary storage for data files ingested by the operator node. In some embodiments, file storage 606 may include a local filesystem, RAM, disk-based storage devices (e.g., solid-state drives, hard drives) or external storage devices. File storage 606 may be used to archive original data files in their native format.

Database service 608 may store structured data derived from the ingested files, allowing for efficient query execution. Database service 608 may be implemented using a relation database management system (DBMS) such as PostgreSQL or MySQL, or a non-relational DBMS such as MongoDB and may store records and measurements tagged with file identifiers and timestamps.

Data ingestion service 610 may interface with external data sources and is responsible for receiving and preprocessing incoming data. Data ingestion service 610 may employ southbound connectors, including REST, OPC UA or MQTT to retrieve data from heterogeneous external systems. The operator node 600 is format-agnostic and data ingestion service 610 may handle structured, semi-structured or unstructured content.

Hardware abstraction layer 612 may provide a standardized interface between the software stack and the physical hardware resources of operator node 600. Hardware abstraction layer 612 may include firmware, virtualization layers or device drivers that enable the software stack to operate across diverse hardware configurations.

Command-line interfaces (CLIs) and application programming interfaces (APIs) 614 provide user-facing and programmatic access to operator node 600. CLIs and APIs 614 may serve as northbound connectors, offering standardized interfaces (e.g., REST or SQL) that abstract the underlying complexity of the system and enable integration of operation node 600 with external applications, workflows and query processing components.

FIG. 7 is a block diagram illustrating an embodiment of a shared metadata layer. In some embodiments, shared metadata layer 702 may be implemented as a decentralized ledger, such as a blockchain ledger, although centralized or hybrid implementations may also be used. Shared metadata layer 702 maintains a collection of indexable and searchable policies that capture both the data ontology and the structure of the decentralized physical infrastructure network (DePIN). In some implementations the shared metadata serves as an index to locate nodes by the type of data or data tables they service. This information enables the query process to identify the nodes that host the data that need be evaluated to satisfy the query.

Shared metadata layer 702 may include policies which are able to be queried and are organized as a list of data storage records 704. Each policy or record may define a set of descriptive attributes for data available within the network, such as temporal bounds, source identifiers, semantic descriptors, and storage information. These attributes allow clients and operator nodes to resolve requests into the corresponding set of files, database tables, or operator nodes that host the relevant data. As illustrated, the data storage records 704 may include, for example, a policy relating to a temperature sensor associated with a pump at the Houston plant of the company ACME, and another policy relating to an energy meter associated with a turbine at the California plant of the company ACME. The records may further indicate which specific nodes currently host the corresponding data files. Policies may represent any type of metadata information that is needed to facilitate the operations of the inventions.

Shared metadata layer 702 may also include filter policies 706. Filter policies 706 may allow a user, process, or operator to filter displayed metadata results based on a number of qualifiers, including but not limited to company, geographic location, machine type, device identifier, instrument type, tables being queried and date range. These filter policies enable targeted discovery of data sources and reduce the scope of metadata presented to users or automated processes.

In some embodiments, shared metadata layer 702 may further comprise file discovery component 708. File discovery 708 may use the indexed policies to resolve data-related queries into the physical files or datasets that contain the requested data. In certain implementations, shared metadata layer 702 may store only pointers to the physical files, while in other implementations the metadata layer itself may host the physical files. In either case, integrity and authenticity may be preserved independently of storage location by associating each file with a cryptographic hash, enabling deterministic verification of its contents. This ensures that shared metadata layer 702 operates as a trustworthy and tamper-evident index across heterogeneous storage providers within the decentralized query verification framework.

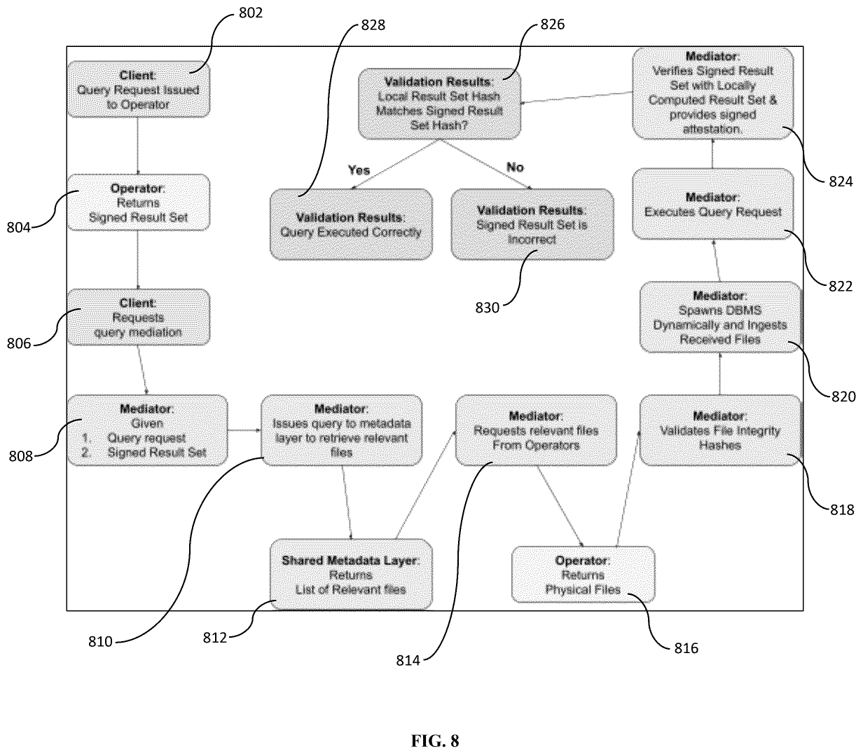

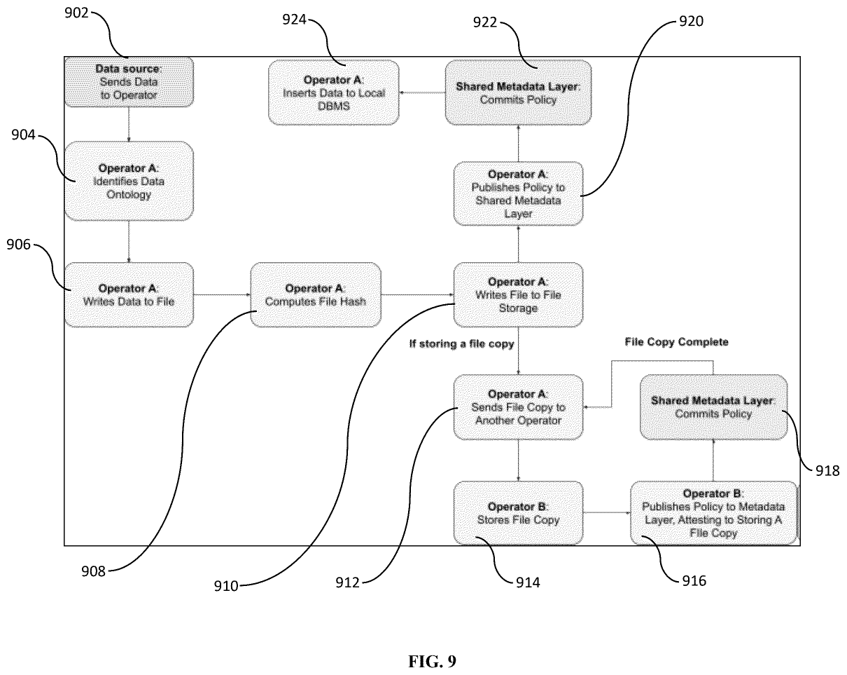

FIG. 8 is a block diagram/flowchart illustrating one embodiment of the method of validating result sets. The method ensures that result sets returned by operator nodes can be independently validated by a mediator.

Initially, at step 802 a client may issue a query request to an operator. Then, at step 804, the operator may then execute the query against its locally stored data and return a signed result set back to the client. The signed result set may include the result data along with a cryptographic signature or attestation generated by the operator to certify the integrity of the result. In some embodiments, the operator's attestation also incorporates an attestation to the state of the shared metadata layer at the time of execution, ensuring that the response is bound to a verifiable system state.

Upon receiving the signed result set, at 806, the client may request query mediation. At step 808, the client may transmit both the original query request and the signed result set to a mediator for validation. The mediator functions as an independent verifier that can confirm the correctness of the operator's result set.

To validate the query, at step 810 the mediator may consult the shared metadata layer to identify the files and datasets that are relevant to the request. Subsequently, at step 812, the shared metadata layer may return a list of files and associated metadata, including the operator nodes that host the data, attributes, and file hashes. Using this information, at step 814, the mediator requests the relevant files from the appropriate operator nodes, which may at step 816 return the corresponding files.

The process proceeds to step 818, where upon receiving the files, the mediator validates the file integrity hashes to ensure that the files have not been altered or tampered with. If the calculated file hashes do not match the value(s) that was published to the shared metadata layer at the time of file insertion, the mediator may conclude that the operator node is malicious. If the calculated file hash does match the value that was published to the shared metadata layer at the time of data insertion, the process may continue to step 820. At step 820, the mediator may spawn a database management system (DBMS) and ingest the received files into the DBMS to prepare them for query execution.

At step 822, the mediator may then execute the original query request against the ingested data. At step 822, the mediator may compute the result set of the original query using the verified files, this result set produced by the mediator may be referred to as the validated set. At step 824, the mediator node may verify the locally computed result set, the validated set, with the operated signed result set, the tested set. Step 824 may comprise sub operation 826. At sub operation 826 it is determined whether the hash values and or result sets match produced by the mediator and operator nodes match. If at sub operation 826, it is determined that the tested set and the validated set are the same, the mediator may proceed to step 828 where the mediator concludes that the query executed correctly and that the signed result set is valid. In this case, the mediator may generate its own signed attestation confirming that the result set has been validated and matches the expected output. If it is determined at sub operation 826 that the two hash values, the two result sets do not match, the mediator may proceed to step 830 and conclude that the tested set is incorrect. In some embodiments, the determination of an incorrect result set may lead to penalty for the operator node that provided said incorrect result set.

In some embodiments, this verification process may be recursive meaning that a mediator's signed attestation may itself be subject to verification by another mediator, thereby enabling verification at both intermediate and final stages of query execution. This iterative attestation mechanism ensures that query results are trustworthy, reproducible, and demonstrably derived only from authenticated operators and the metadata state at the moment of execution.

FIG. 9 is a block diagram/flowchart illustrating an exemplary method of inserting data into a DePIN. FIG. 9 illustrates how data received from an external source is processed by an operator node, registered in the shared metadata layer, and optionally replicated to a secondary operator for redundancy.

The process may begin at step 902 where a data source may transmit structured or unstructured data to an operator node A through a streaming interface such as REST, MQTT, gRPC, or OPC UA. Upon receipt, at step 904, an operator node, in this case operator node A, may generate a data ontology that identifies descriptive attributes such as the earliest and latest timestamps, semantic descriptors, and any associated attribute metadata for the incoming dataset.

Operator node A may then, at step 906, serialize the data to a file format. At step 908 after the file is created, operator node A may compute a cryptographic hash of the file contents. Subsequently at step 910, the operator node, operator A, may write the file-to-file storage.

At step 920, the operator node, operator A, may then publish a data storage policy to the shared metadata layer. The policy may describe the data ontology, reference the computed file hash, and record the storage location identifying operator node A as the hosting node. At step 922, the shared metadata layer may then commit the policy to the shared metadata to establish a verifiable record of the data, its attributes, and storage location within the decentralized network. Once the shared meta data layer has committed the policy, at step 924, the operator node, operator node A may ingest the data into a local database management system (DBMS). Examples of database management system may include but are not limited to MongoDB, MySQL, Oracle, PostgreSQL, and SQLite.

In some embodiments, a client may request redundant storage. In such cases, after step 910 the process may proceed to step 912, where the operator node may send a copy of the file(s) to another operator node, in this case, operator node B. At step 914, operator node B may store the files, compute its own attestation. Then at step 916, operator node B may publish its own policy to the shared metadata layer confirming its role as a file host alongside operator node A. The shared metadata layer may then, at step 918, commit this replication policy, establishing a record that operator B is hosting a verifiable copy of the data file. The replication process is finalized only after operator node A observes that operator node B's policy has been successfully committed to the shared metadata layer.

For the figure descriptions above, it can be assumed that most correspondingly labeled elements across the figures (e.g., 105 and 205, etc.) possess the same characteristics and are subject to the same structure and function. If there is a difference between correspondingly labeled elements that is not pointed out, and this difference results in a non-corresponding structure or function of an element for a particular embodiment, example or aspect, then the conflicting description given for that particular embodiment, example or aspect shall govern.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims.

If present, use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

As used herein and throughout this disclosure, the term “edge node” refers to any electronic device capable of communicating across a network. An edge node may have a processor, a memory, a transceiver, an input, and an output. Examples of such devices include, without limitation, computer servers, Raspberry Pi devices, network switches, and gateways, cellular telephones, personal digital assistants (PDAs), portable computers, and more generally, any device with sufficient compute, storage, and communication capability to participate in edge processing and network functions may qualify as an edge node. The memory stores applications, software, or logic. Examples of processors are computer processors (processing units), microprocessors, digital signal processors, controllers and microcontrollers, etc. Examples of device memories that may comprise logic include RAM (random access memory), flash memories, ROMS (read-only memories), EPROMS (erasable programmable read-only memories), and EEPROMS (electrically erasable programmable read-only memories). A transceiver includes but is not limited to cellular, GPRS, Bluetooth, and Wi-Fi transceivers.

“Logic” as used herein and throughout this disclosure, refers to any information having the form of instruction signals and/or data that may be applied to direct the operation of a processor. Logic may be formed from signals stored in a device memory. Software is one example of such logic. Logic may also be comprised by digital and/or analog hardware circuits, for example, hardware circuits comprising logical AND, OR, XOR, NAND, NOR, and other logical operations. Logic may be formed from combinations of software and hardware. On a network, logic may be programmed on a server, or a complex of servers. A particular logic unit is not limited to a single logical location on the network.

Edge nodes may communicate with one another and with other elements of the system via one or more networks. In some embodiments, communication occurs over a Transmission Control Protocol (TCP) network. In other embodiments, communication may utilize additional or alternative protocols and networking technologies, including User Datagram Protocol (UDP), Hypertext Transfer Protocol (HTTP/HTTPS), Message Queuing Telemetry Transport (MQTT), WebSocket, cellular networks (e.g., 4G, 5G), wireless local area networks (Wi-Fi), wired Ethernet, or other communication frameworks suitable for enabling peer-to-peer and client-server interactions among edge nodes and between edge nodes and external systems. A “network” can include broadband wide-area networks, local-area networks, and personal area networks. Communication across a network can be packet-based or use radio and frequency/amplitude modulations using appropriate analog-digital-analog converters and other elements. Examples of radio networks include GSM, CDMA, Wi-Fi and BLUETOOTH.RTM. networks, with communication being enabled by transceivers. A network typically includes a plurality of elements such as servers that host logic for performing tasks on the network. Edge nodes may be placed at several logical points on the network. Edge nodes may further be in communication with databases and can enable communication devices to access the contents of a database. For instance, an edge node hosts or is in communication with a database hosting users'data which is serviced through a network.

A nano/micro data center refers to a small-scale, localized data center designed to provide computing, storage, and networking capabilities closer to the end users or devices. Key characteristics of a nano/micro data center include low latency, local processing, small in size, limited resources, and energy efficiency.

A cloud or centralized data center refers to a large-scale facility that provides computing, storage, and networking resources to users or businesses over the internet. These data centers are typically owned and operated by cloud service providers that have a strong reputation, like Amazon Web Services (AWS), Microsoft Azure, or Google Cloud. Key characteristics include centralized processing, vertical scalability, high capacity, and high latency.

As used herein, the terms “node” and “edge node” are used interchangeably, as the nodes of the present invention are positioned at the edge of the network. A node may refer to any compute instance having a processor (e.g., CPU, GPU, or specialized accelerator), memory, and an operating system (e.g., Windows, Linux, or a real-time operating system) that participates in the processes of the invention. Examples of nodes include, without limitation, large-scale servers, small compute instances such as Raspberry Pi devices, gateways, industrial controllers, or sensors with embedded compute capability. More generally, a node may encompass any hardware or virtualized instance capable of executing instructions and contributing to the distributed functions of the edge network. Nodes may be assigned to one or more roles within the system. For example, a query node may orchestrate query processes, while an operator node may host and serve data. These roles represent functional assignments to nodes; however, the separation of roles is primarily for explanatory convenience. A single node may perform multiple roles simultaneously, and users or applications may define or declare additional roles beyond those explicitly described herein. Accordingly, the invention contemplates both fixed and dynamic role assignments, allowing flexible orchestration of compute and data services across the network of nodes.

The phrase “shared metadata” or “shared metadata layer” may be used to refer to a layer of information about data, nodes and resources that participate in the processes of the invention. The metadata is available to all the nodes of the network and can be maintained in many ways. For example: using a blockchain or as a centralized database. Example of information contained in the metadata: the members of the network and the IPs and Ports provided by each node for peer-to-peer communication, how data is distributed to nodes in the network and any other information that is needed to orchestrate the processes of the invention. In one implementation of the invention, the shared metadata is organized in a blockchain ledger and operations on the metadata (like read, write and update) are through a smart contract that transacts on the blockchain ledger.

An operator node may refer to a node that hosts data and satisfies queries on the data. The data on an operator node can reside in a database (e.g., MySQL, Oracle, PostgreSQL, SQLite, MongoDB) or as a set of files or using any other way or in multiple ways. An operator node of the invention is able to satisfy queries over the data set that is hosted locally on the node.

A query node may refer to a node that orchestrates a query process. A query node may receive a query from a user or an application and using the shared metadata, may determine which operators host the data that needs to be evaluated to satisfy the query. The query node may then deliver the query to these operators and collect the result set returned from each participating operator. Then, the query node may aggregate all the returned results sets to provide a unified result to the user or application. The process of distributing queries to nodes in the network is similar to a MapReduce process. In some embodiments, query nodes may be stateless. The orchestration of a query process does not require prior knowledge of the data or the network topology. Instead, the query node operates by combining the information specified in the query with information maintained in the shared metadata, and by aggregating the replies received from operator nodes into a unified result set. Because of this stateless design, a query node can be instantiated and deployed by users or applications within their own trusted environment, thereby enabling such users and applications to retain full control over the query process without reliance on preconfigured infrastructure.

Source data may refer to data that is transferred from a data source (e.g., a sensor, a programmatic logic controller, or an application) to the operator nodes. The source data is organized in files on the sender node or the operator node. The format of the data in the file can be JSON, and each file is associated with a file identifier. The file identifier includes the hash value of the data contained in the file. In the context of the invention, the source data is owned by the data owner and is provided to an operator node for processing. Said processing includes storage of the data and satisfying queries over the data.

A local dataset may refer to a dataset maintained on a storage device connected to a node and is accessible by the node. The data set can be organized in different ways. For example, maintained as files on the file system or stored in a database. A local dataset contains the source data or subsets of the source data.

A malicious node refers to participants in the network that act with dishonest or harmful intent. These nodes deviate from the established protocol, potentially undermining the security, integrity, and functionality of the protocol. One example is an operator node that satisfies queries with erroneous result sets. Malicious nodes, sometimes called malicious operators, may be motivated to return erroneous result sets for no reason, or to jeopardize the network, or for financial gains; for example, to lower costs by limiting query execution time in cases of long running queries. As queries consume computing resources like CPU and network as well as consuming electricity, returning malicious or incorrect results may provide computing and financial gains to the operator. Another example of a malicious node is a query node that ignores result sets returned from operators. These nodes may be motivated by an effort to enforce unjustified penalties, which can be for their financial gains. In some embodiments, query nodes may be inherently trusted, as they are stateless and can be initiated and controlled directly by the application or user issuing the query. In contrast, this assumption of trust does not apply to operator nodes. Operator nodes maintain data for extended durations and may be operated by third parties that are not under the control of the data owner or the query initiator. Accordingly, while query nodes can be deployed within a trusted environment, operator nodes require mechanisms to ensure correctness, integrity, and accountability of the data and responses they provide.

Time series data refers to information that is recorded with an associated timestamp, allowing for the analysis of trends and changes over time. In the context of the Internet of Things (IoT), time series data is particularly valuable as it reflects variations in sensor readings and environmental conditions. For instance, consider a temperature sensor that continuously monitors the ambient temperature. Each measurement is accompanied by a timestamp, which indicates when that particular reading was taken. This structured data format allows for detailed analysis, enabling users to identify patterns, fluctuations, and anomalies over time. By leveraging time series data, IoT applications can provide insights into performance, optimize operations, and facilitate predictive maintenance, among other benefits. Time series data in IoT not only captures real-time changes but also plays a crucial role in making informed decisions based on historical trends. In the context of the invention, source data may be time series data.

In the context of the invention, a time range refers to a specific interval or period defined by two points in time, a start time and an end time. This range identifies the timestamps of data relevant to satisfying queries, ensuring that only the necessary data within this defined period is considered for analysis and processing.

A data set time range is derived from the earliest and latest timestamps present in that specific dataset. A file with data is considered a data set and the entries in the file determine the time range.

A query time range refers to a time range specified in a query. It is used to limit the scope of data to be processed, ensuring that only records within the specified time interval are evaluated and or returned. This concept is commonly applied in time series databases, IoT data, and any system where temporal data is critical. An example is: If an IoT system logs temperature readings every minute, a query might request data within the time range from 8:00 AM to 9:00 AM. The system would then return only the temperature data recorded during that hour.

Structured Query Language (SQL) is a standardized programming language used to manage and manipulate relational databases. It is designed for querying, updating, inserting, deleting, and managing data stored in a relational database management system (RDBMS). SQL allows users to create, read, update, and delete (CRUD) data in databases, as well as define data structures like tables, and set permissions or constraints on the data. An SQL query is a query specified using SQL.

A service level agreement (SLA) defines the expected level of service between a service provider and a service consumer. It outlines specific performance metrics, responsibilities, and guarantees regarding service delivery, ensuring that both parties have a clear understanding of their obligations and expectations. In the context of the invention, these guarantees can include costs, physical location of the nodes that host the data, operator availability, the type of compute resources provided, including CPU, RAM and storage as well as the network bandwidth provided.

A network protocol refers to a set of rules and conventions that determine how data is transmitted over the network, exchanged between nodes and managed on the operator nodes including the rules that deliver the query process. The network protocol ensures that nodes on a network can communicate and operate effectively, regardless of their underlying hardware or software differences. In the context of the invention, the network protocol includes a process to identify malicious nodes. A network protocol or a portion of the network protocol may be implemented in a smart contract.

Blockchain refers to a decentralized digital ledger technology that securely records transactions across multiple computers in such a way that the registered data cannot be altered retroactively without the consensus of the network. Each transaction is grouped into a block, which is linked to the previous block, forming a chain of blocks—hence the name “blockchain.” This technology enhances transparency, as all participants in the network have access to the same information, and it provides security through cryptographic methods, making it resistant to tampering and fraud. Blockchain is the foundational technology behind cryptocurrencies like Bitcoin and Ethereum, but its applications extend to various fields, including supply chain management, healthcare, and voting systems. In the context of the invention, a blockchain may be employed to store metadata, thereby making that metadata globally accessible to all nodes across the network.

A smart contract is a self-executing program with the terms of the agreement directly written into code. It automatically enforces and executes the terms of a contract when predefined conditions are met, without the need for intermediaries like lawyers or brokers. Smart contracts run on blockchain networks, ensuring transparency, security, and immutability. In the context of the invention, a smart contract may be employed to enforce honest behavior among network participants. If a member is declared dishonest by a network validator, the smart contract automatically applies the prescribed penalties, ensuring transparent and tamper-resistant enforcement of network rules. In addition, a smart contract can be employed to store, manage, and service system metadata, in a cryptographically verifiable manner, without the existence of a single point of failure. In one embodiment, the metadata is stored as a collection of policies, organized and indexed as key-value pairs.

A policy is a specification of a set of rules or information. In the context of the invention information updated on the shared metadata: the collection of policies make the shared metadata whereas each policy is a subset of the metadata. For example, policies represent the nodes which are members of the network. These policies include their identification in the network, their physical location, how to communicate with the nodes (like IP and Port) and the protocol to use. A second example is how data is distributed-if an operator is hosting the data of table X, the operator will publish a policy that identifies the data services provided by the operator with table X. With this approach, when a query is issued, the policies serve as a directory to locate the nodes that host the data associated with the table (target nodes), and service the IP and Port of each target node to a MapReduce process that interacts with the target nodes in the process to of satisfying the query. In some embodiments the shared metadata is organized in a decentralized blockchain, or in a private blockchain, whereas, in a different embodiment the shared metadata is organized in a centralized database, or in any other way that can service the metadata to the members of the network.

The phrase “representative” may be used to refer to any identifier, token or cryptographic hash value that is able to uniquely correspond to data stored, processed or transmitted. A representative may include, but is not limited to, (i) file identifiers, which may comprise a cryptographic hash of contents of the file, and associated file metadata such as a timestamp or time range, (ii) a file hash calculated from source data, (iii) a hash value of a result set or validating set or (iv) any other derived value that enables the identification, verification, or validation of corresponding data. Representatives may be published onto the shared metadata layer, stored locally on a node, or exchanged between nodes for the purpose of ensuring data integrity.

A hash value, or simply a “hash”, is a string of characters that is generated from input data of any size using a hash function. It is often used in computer science and cryptography to uniquely represent data in a compact form. A hash function is a mathematical algorithm that takes an input or “message” and returns a fixed-size string of bytes that represents the input data. In the context of the invention, hash values may be used to represent information for purposes of identification and verification, enabling, by publishing these hashes on a blockchain, a tamper-evident validation of elements such as SQL query text, data sets organized in files, and query result sets. Hash values are considered representatives of the information hashed. For example, the hash value of a result set is considered a representative of the result set. In the context of the invention, query result sets are compared by comparing their representatives such that if the hash values of two (2) results sets are equal, the result sets of the two (2) queries are considered to be identical.

Sha-256 is a secure cryptographic hash function that takes in an input and produces a fixed-length 256-bit hash value. Key characteristics of the SHA-256 hash function are that it is deterministic meaning the same input always results in the same hash, collision resistant meaning that no two unique inputs results in matching hashes, and irreversible meaning that it is not possible to generate the input given a hash.

Signed attestation refers to a formal declaration or verification of facts, information, or data that is cryptographically signed by an authorized entity such as an individual, organization, or system to ensure its authenticity and integrity. It serves as proof that the information contained within the attestation was generated by the attestor and has not been tampered with.

The use of private & public key (asymmetric) encryption is a cryptographic technique that uses a pair of keys to secure communication, authenticate users, and protect data. The public key may be shared openly and can be distributed to anyone. It is used to encrypt data or verify a digital signature. Data encrypted with the public key can only be decrypted with the corresponding private key. The private key is kept secret by the owner. It is used to decrypt data or generate a digital signature. Data encrypted with the private key can only be decrypted by the corresponding public key, and vice versa for verification.

Advanced Encryption Standard (AES) is a widely used symmetric encryption algorithm that secures data through encryption and decryption. It is one of the most popular encryption standards globally and is used in various applications, including secure communications, data storage, and financial transactions. AES operates on fixed-size blocks of data.

The concept of a cipher nonce (short for “number used once”) is a critical component in cryptography, particularly in encryption algorithms that operate in certain modes (like galois/counter mode or counter mode). The nonce is a random or pseudo-random value that is used to ensure that the same plaintext encrypts to different ciphertexts each time it is encrypted with the same key.

Symmetric encryption uses the same key for both encryption and decryption. This means that both the sender and receiver must securely share the secret key.

A secret-sharing process may be used to securely share encrypted information, such that the receiver can decrypt and view the raw contents without leaking the contents. For example, one of many ways to share keys between node A and B is through the following steps. Node A maintains the public/private key pair puA and prA and node B has the public/private key pair puB and prB. If node A wants to send an encrypted message to node B, node A does the following: generate an AES key and cipher nonce; encrypt its message with the AES key and cipher nonce; encrypt the AES key with node B's public key; sends node B the following: an encrypted message, an encrypted AES key, a cipher nonce. Then to decrypt the message, Node B does the following: decrypt the AES key using the cipher nonce and node B's private key; use the decrypted AES key to decrypt the encrypted message.

A result set is the collection of data returned by a database or search system in response to a query. When a query, typically written in a query language like SQL is executed, the system processes it by scanning the relevant database tables and applying the requested filters, conditions, or calculations. The result set contains the rows and columns of data that meet the specified criteria in the query. In the context of the invention, a correct result set refers to the data returned by a query that accurately matches the specified conditions, filters, and requirements outlined in the query. To be considered correct, the result set must contain all and only the data that adheres to the query's logic without any errors, omissions, or unexpected results. A result set may be hashed to generate a hash value uniquely representing that set. In the context of the invention, when a query result is contested, the query is re-executed on the relevant source data and a separate validation process generates a new hash of the regenerated result set. This hash is then compared to the originally published hash to confirm the integrity and accuracy of the operator's reported result.

A file identifier (or file ID) serves as a serialization that reflects the order in which data from the files was inserted into the database. While serialization can be implementation dependent, if the serialization method is strictly increasing, then two files with the file ID 4, 5, respectively, means that the file with ID 4 was inserted into the database before the file with file ID 5. In the context of the invention, the file ID may represent the state of the database, since each data element in the database is derived from a source file. If the last file ID used to update the database is N, the database contains all information from source files 1 through N. A file identifier, is a representative of a file.

A state channel is a technique used in blockchain and cryptocurrency systems to enable off-chain transactions between participants while maintaining the security and trustless nature of the underlying blockchain. It allows multiple parties to interact and exchange assets or data off-chain, reducing the load on the main blockchain, minimizing fees, and improving scalability.

AnyLog refers to a software company providing decentralized data infrastructure: AnyLog provides a decentralized architecture that enables data to be processed, stored, and managed directly at the edge of the network, reducing the need for centralized cloud storage. This is critical for applications where low latency, data sovereignty, and real-time decision-making are necessary.

EdgeLake is a Linux Foundation project. EdgeLake provides a decentralized architecture, allowing data to be stored and processed closer to where it is generated, at the edge, rather than relying on centralized cloud infrastructure. This reduces latency, improves data privacy, and optimizes network bandwidth usage.

Throughout this description, the aspects, embodiments or examples shown should be considered as exemplary, rather than limitations on the apparatus or procedures disclosed or claimed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

If means-plus-function limitations are recited in the claims, the means are not intended to be limited to the means disclosed in this application for performing the recited function, but are intended to cover in scope any equivalent means, known now or later developed, for performing the recited function.

Claim limitations should be construed as means-plus-function limitations only if the claim recites the term “means”in association with a recited function.

If any presented, the claims directed to a method and/or process should not be limited to the performance of their steps in the order written, and one skilled in the art can readily appreciate that the sequences may be varied and still remain within the spirit and scope of the present invention.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples. Hence, the scope of the invention is defined by the accompanying claims and their equivalents. Further, each and every claim is incorporated as further disclosure into the specification.

What is claimed is:

1. A method performed by a mediator node to validate result sets within a decentralized physical infrastructure network (DePIN), the method being operable on a network of nodes wherein each node includes at least one computer system comprising at least a processor, a memory and a computer program comprising processor-executable instructions stored on a non-transitory processor-readable medium, the DePIN comprising:
a shared metadata layer;
at least one data source;
at least one client configured to issue a query and request validation of a result set;
a plurality of nodes in data communication with each other, the shared metadata layer, the at least one data source and the at least one client, the plurality of nodes comprising an operator node and a mediator node;
the method comprising:
obtaining, by the mediator node, the query issued by the at least one client that is being contested;
obtaining, by the mediator node, a query time range associated with the query issued by the at least one client;
obtaining, by the mediator node, from the shared metadata layer, one or more file identifiers that are associated with the query time range;
determining, by the mediator node, from the shared metadata layer, the operator node that stores one or more data files associated with the one or more file identifiers;
obtaining, by the mediator node, from the shared metadata layer, a representative of the result set produced by the operator node;
requesting and receiving, by the mediator node, from the operator node the one or more data files, each data file being associated with one of the one or more file identifiers;
verifying, by the mediator node, the one or more data files by calculating for each data file, a hash value, and comparing each calculated hash value to a corresponding hash value published in the shared metadata layer by the operator node; and
validating, by the mediator node, the result set by executing the query issued by the at least one client on data contained in the one or more verified data files to generate a validating set and comparing a representative of the validating set with a representative of the result set to determine accuracy of the result set.

2. The method of claim 1, wherein each file identifier comprises a cryptographic hash of the contents of the data file.

3. The method of claim 1, further comprising: imposing a penalty on the operator node, when the one or more calculated hash values are not equal to the one or more corresponding hash values published in the shared metadata layer, or when the representative of the validating set is not equal to the representative of the result set.

4. The method of claim 1, further comprising; imposing a penalty on the client when the representative of the validating set is equal to the representative of the result set.

5. The method of claim 1, wherein the one or more data files stored on the operator node are encrypted prior to storage using a symmetric encryption algorithm or a public-key encryption scheme.

6. The method of claim 1, further comprising: generating, by the mediator node, a signed attestation of the comparison of the representative of the validating set and the representative of the result set, and publishing the signed attestation to the shared metadata layer.

7. The method of claim 1, wherein the query processed by the operator is executed using a database or process that does not participate in the validation process or generate input required by the validation process that is not necessary to satisfy the query.

8. The method of claim 3, wherein the penalty comprises confiscating staked tokens of the operator node that provides the representative of the result set not equal to the representative of the validating set.

9. A method for enabling a decentralized physical infrastructure network (DePIN), the method being operable on a network of nodes wherein each node includes a computer system comprising at least a processor, a memory and a computer program comprising processor-executable instructions stored on a non-transitory processor-readable medium, the DePIN comprising:
a shared metadata layer;
a plurality of operator nodes in data communication with each other and with the shared metadata layer, wherein the plurality of operator nodes form a peer-to-peer network;
at least one data source in data communication with at least one of the plurality operator nodes;
a client device in data communication with at least one of the plurality of operator nodes;
the method comprising:
receiving source data by at least one of the plurality of operator nodes from the at least one data source;
computing one or more original hash values based on the content of the source data;
publishing the one or more original hash values to the shared metadata layer;
generating a request by the client device for the source data stored on the at least one of the plurality of operator nodes;
receiving a result set by the client device, from the at least one of the plurality of operator nodes;
validating the source data by recalculating one or more hash values of the source data and comparing the one or more recalculated hash values to the one or more original hash values; and
validating the result set, by re-executing the request on the validated source data to generate a representative of the validating set and comparing a representative of the validating set with a representative of the result set to determine accuracy of the result set.

10. The method of claim 9, further comprising: confirming that the source data was properly stored by the at least one of the plurality of operator nodes by calculating a new hash value and comparing the new hash value with the original hash value.

11. The method of claim 9, further comprising: imposing a penalty on the at least one of the plurality of operator nodes when the new hash value is different from the original hash value, when the recalculated hash value is different from the original hash value or when the representative of the validating set is different from the representative of the result set.

12. The method of claim 9, further comprising: imposing a penalty on the client device when the representative of the validating set is equal to the representative of the result set.

13. The method of claim 9, wherein the query by the operator is executed using a database or process that does not participate in the validation process or generate input required by the validation process that is not necessary to satisfy the query.

14. The method of claim 9, wherein the request is an SQL query, graph query, JSON query or NoSQL query.

15. The method of claim 9, wherein the source data is time series data, sensor data or unstructured data.

16. The method of claim 9, wherein the source data stored on the at least one of the plurality of operator nodes is encrypted using a secret-sharing scheme.

17. The method of claim 11, wherein the penalty is automatically enforced by a smart contract on the shared metadata layer.

18. A method for improving trust in a decentralized physical infrastructure network (DePIN), the method being operable on a network of nodes wherein each node includes at least one computer system comprising at least a processor, a memory and a computer program comprising processor-executable instructions stored on a non-transitory processor-readable medium, the method comprising:
receiving, by a client device, a result set created by executing a request on a source data from at least one of a plurality of operator nodes of the DePIN;
validating the source data by calculating one or more hash values of the source data and comparing the one or more calculated hash values with one or more original hash values published on a shared metadata layer; and
validating the result set, by executing the request on the validated source data to generate a validating set and comparing the validating set with the result set to determine accuracy of the result set.

19. The method of claim 18, further comprising: confirming that the source data was properly stored by the at least one of the plurality of operator nodes by calculating a new hash value and comparing the new hash value with the original hash value.

20. The method of claim 19, further comprising: imposing a penalty on the at least one of the plurality of operator nodes when the new hash value is different from the original hash value, when the calculated hash value is different from the original hash value or when the validating set is different from the result set.
